(19) United States
(12) Patent Application Publication
(10) Pub. No.: US 2024/0270541 A1
(43) Pub. Date: Aug. 15, 2024

(54) BALCONY HOIST

(71) Applicant: Donald Veloz, JR., Katy, TX (US)

(72) Inventor: Donald Veloz, JR., Katy, TX (US)

(21) Appl. No.: 18/110,150

(22) Filed: Feb. 15, 2023

(51) Int. Cl. B66C 23/20; B66F 11/00

(52) U.S. Cl. CPC B66C 23/201; B66F 11/00

(57) ABSTRACT

A hoist apparatus for lifting a load onto a balcony includes a base and a boom arm which is extendable away from the base. A pulley is coupled to the boom arm adjacent to a distal end of the boom arm relative to the base. A winch is provided for hoisting a load via a cord mounted on the pulley. The apparatus is configured so that, after lifting the load, the winch can wind the cord to retract the boom arm, moving the load toward a destination balcony. The base is mountable to a second balcony overhanging the destination balcony.

### BACKGROUND OF THE INVENTION

### (1) Field of the Invention

The disclosure relates to hoists and more particularly pertains to a new hoist for lifting a load onto a balcony.

### (2) Description of Related Art Including Information Disclosed Under 37 CFR 1.97 and 1.98

U.S. Pat. No. 6,782,972 discloses a hoist for lifting a load onto a balcony which comprises a ladder which mounts to the balcony and a gantry that extends from the ladder to a support mounted to the floor of the balcony. Myriad other configurations of general and special-purpose hoists are also found in the prior art. However, the prior art does not disclose a hoist comprising a telescopic hoist which mounts to a second balcony above a destination balcony for lifting a load to the destination balcony.

### BRIEF SUMMARY OF THE INVENTION

An embodiment of the disclosure meets the needs presented above by generally comprising a base which is hollow and has an open end. The base is elongated between the open end and an opposite end of the base. A mounting bracket is coupled to a top side of the base. The mounting bracket has a plurality of holes, and each hole of the plurality of holes extends vertically through the mounting bracket. The mounting bracket is configured for receiving threaded fasteners through the plurality of holes for mounting the base to a bottom surface of a horizontally projecting structure. A boom arm is coupled to the base and is extendable telescopically away from the base through the open end. A pulley is coupled to a lower side of the boom arm and is positioned adjacent to a distal end of the boom arm relative to the base. A winch is coupled to the bottom side of the base. A cord is wound onto the winch. The cord extends around and engaging the pulley, and the cord extends downwardly from the pulley, terminating in a free end.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a hoist apparatus according to an embodiment of the disclosure.

FIG. 2 is a top view of an embodiment of the disclosure.

FIG. 3 is a side view of an embodiment of the disclosure.

FIG. 4 is a front view of an embodiment of the disclosure.

FIG. 5 is a bottom front side perspective view of an embodiment of the disclosure.

FIG. 6 is an in-use view of an embodiment of the disclosure.

FIG. 7 is a block diagram of an embodiment of the disclosure.

### DETAILED DESCRIPTION OF THE INVENTION

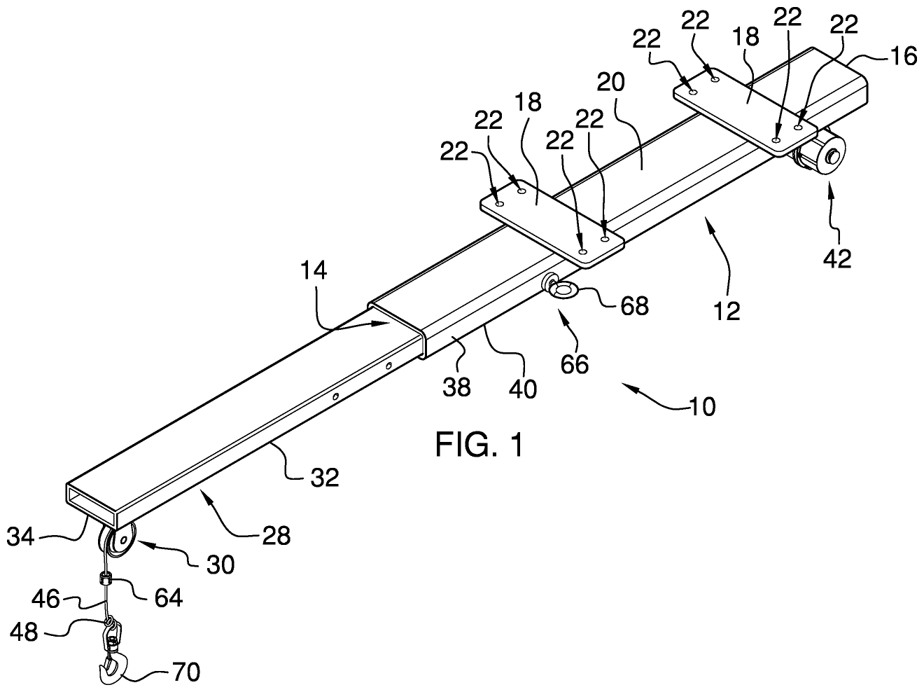

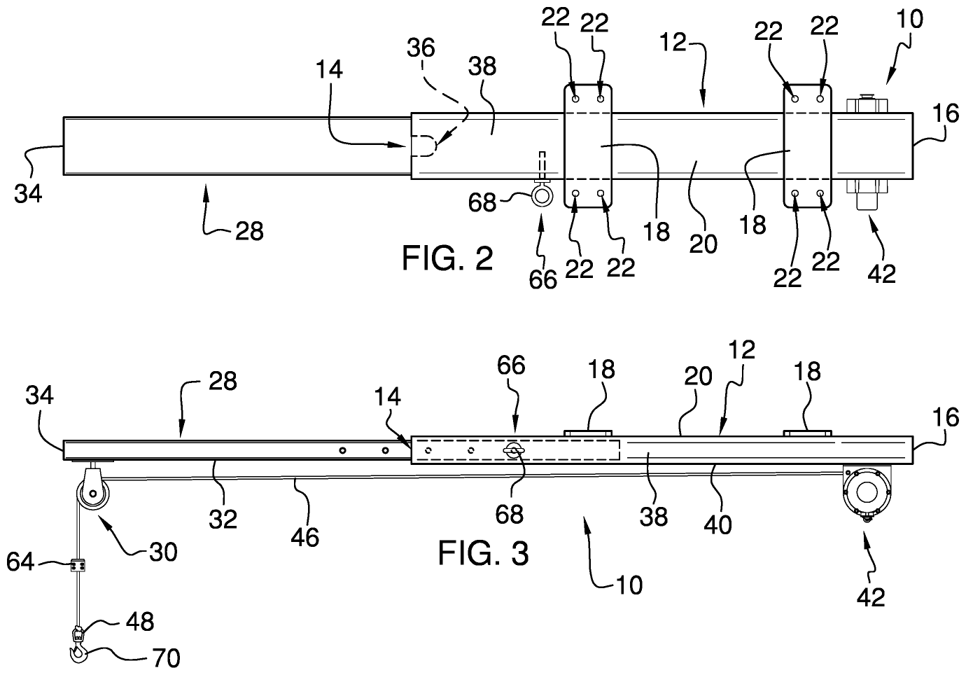

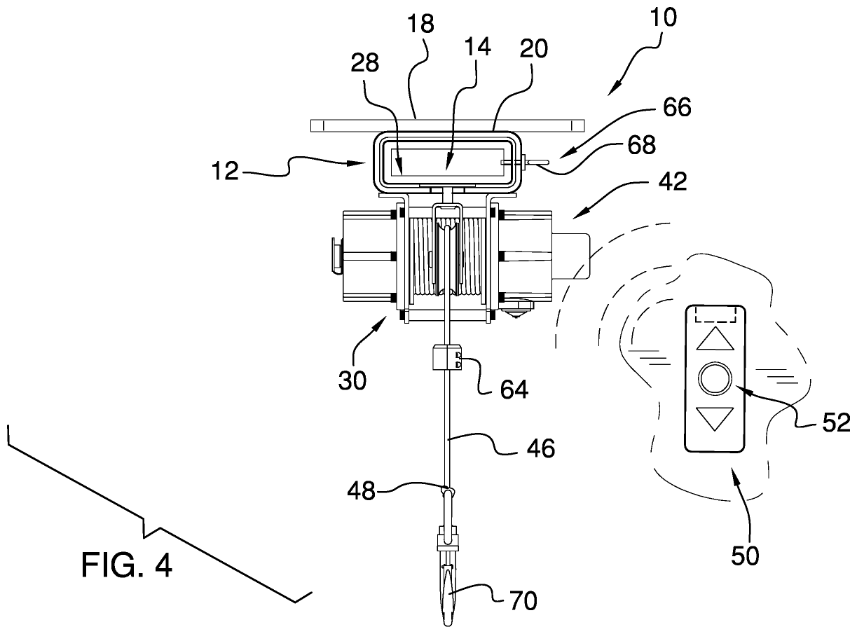

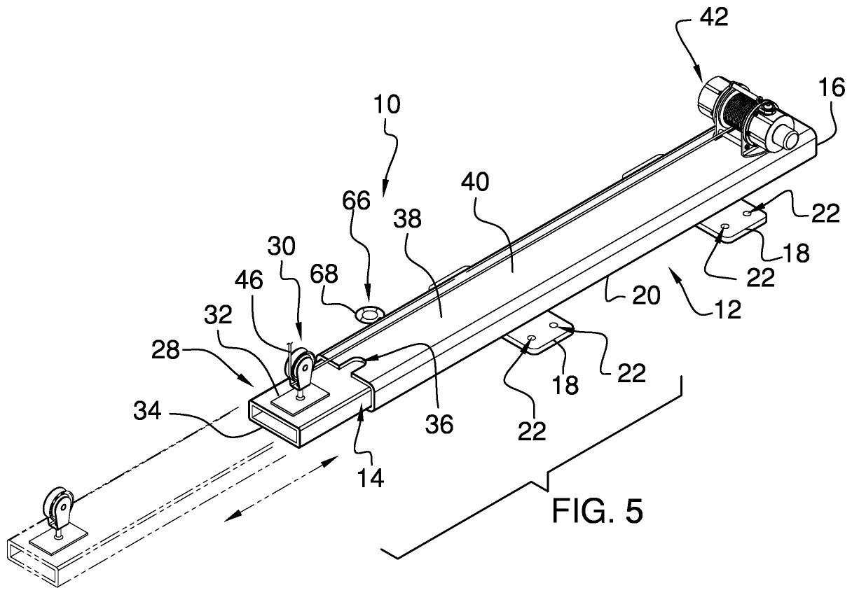

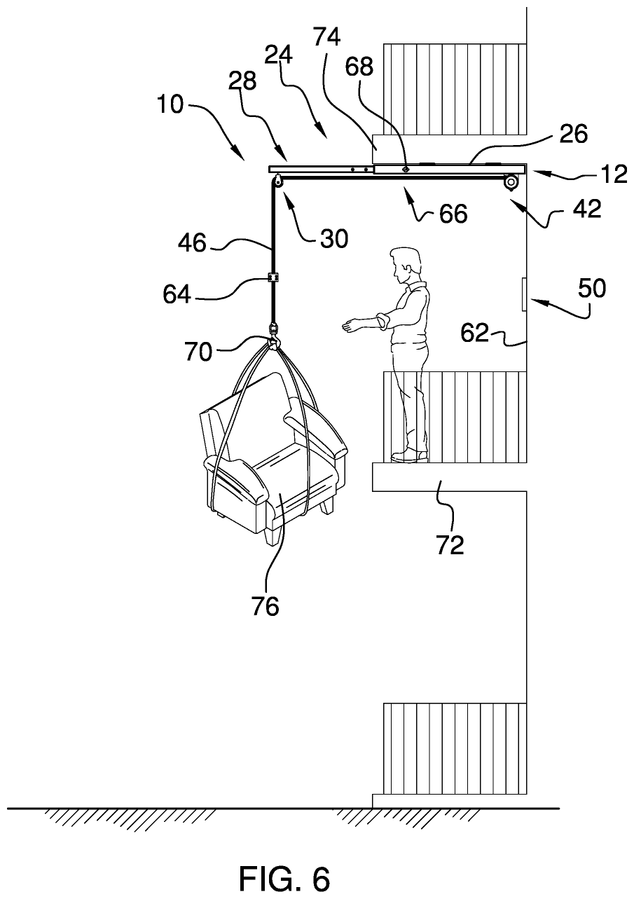

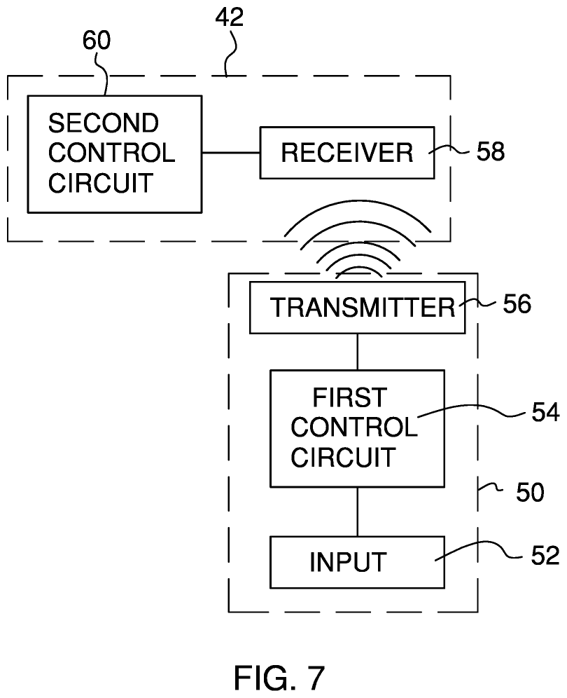

With reference now to the drawings, and in particular to FIGS. 1 through 7 thereof, a new hoist embodying the principles and concepts of an embodiment of the disclosure and generally designated by the reference numeral 10 will be described.

As best illustrated in FIGS. 1 through 7, the hoist apparatus 10 generally comprises a base 12 which is hollow and has an open end 14. The base 12 is elongated between the open end 14 and an opposite end 16 of the base 12. A pair of mounting brackets 18 is coupled to a top side 20 of the base 12. Each mounting bracket 18 of the pair of mounting brackets 18 has a plurality of holes 22, and each hole 22 of the plurality of hole 22 extends vertically through an associated mounting bracket 18 of the pair of mounting brackets 18. The pair of mounting brackets 18 is configured for receiving threaded fasteners through the plurality of holes 22 for mounting the base 12 to a bottom surface 26 of a horizontally projecting structure 24, such as a balcony. Each hole 22 of the plurality of holes 22 is laterally spaced from the base 12.

A boom arm 28 is coupled to the base 12 and is extendable telescopically away from the base 12 through said open end 14. A pulley 30 is coupled to a lower side 32 of the boom arm 28 and is positioned adjacent to a distal end 34 of the boom arm 28 relative to the base 12. The base 12 has a notch 36 extending into an outer wall 38 of the base 12 on a bottom side 40 of the base 12 adjacent to the open end 14 for receiving the pulley 30 when the boom arm 28 is retracted toward the base 12. A winch 42 is coupled to the bottom side 40 of the base 12 and includes a motor 44 for driving the winch 42. The winch 42 is positioned closer to the opposite end 16 of the base 12 than to the open end 14, and the mounting brackets 18 are positioned between the winch 42 and the open end 14 of the base 12. A cord 46 is wound onto the winch 42. The cord 46 extends around and engages the pulley 30. The cord 46 extends downwardly from the pulley 30 and terminates in a free end 48.

A controller 50 is operatively coupled to the winch 42. The controller 50 includes an input 52 for selectively winding the cord 46 onto and unwinding the cord 46 from the winch 42. The controller 50 also has a first control circuit 54 which is electrically coupled to the input 52 and a transmitter 56 which is electrically coupled to the first control circuit 54 for transmitting operational signals to the winch 42. The winch 42 includes a receiver 58 which is in signal communication with the transmitter 56. The winch 42 also comprises a second control circuit 60 which is electrically coupled to each of the receiver 58 and the motor 44. The controller 50 may be mounted onto a wall 62 or similar structure. The controller 50 and winch 42 may be electrically powered by an external power source or a pair of power sources, each of which is incorporated into a respective one of the controller 50 and the winch 42.

A catch 64 is coupled to the cord 46 between the pulley 30 and the free end 48 of the cord 46. The catch 64 is shaped to engage the pulley 30 such that the cord 46 is fixed relative to the boom arm 28. The catch 64 frictionally engages the cord 46. A lock 66 engages the boom arm 28 and the base 12 to releasably secure the boom arm 28 to the base 12. The lock 66 comprises a locking pin 68 which extends through the boom arm 28 and the base 12 to secure the boom arm 28 to the base 12 in a selected one of a plurality of locking positions. A hook 70 is coupled to the free end 48 of the cord 46.

The hoist apparatus 10 may also be configured for attachment to other parts of a building structure such as a door, vertical wall, or window frame in situations where no horizontally projecting structure 24 is present.

In use, the base 12 is mounted above a destination balcony 72 and may be mounted to an overhanging balcony 74 positioned above the destination balcony 72. The boom arm 28 is extended from the base 12 and may be secured to the base 12 with the locking pin 68. The winch 42 is driven to unwind the cord 46 such that the free end 48 of the cord 46 and the hook 70 lower below the destination balcony 72. A load 76 is secured to the hook 70. The winch 42 is driven to wind the cord 46 and draw the load 76 upwardly until the catch 64 engages the pulley 30, which fixes the cord 46 relative to the boom arm 28. If the locking pin 68 was used to secure the boom arm 28 to the base 12, it is removed. The winch 42 is driven again to wind the cord 46, which draws the boom arm 28 into the base 12 and the load 76 onto the destination balcony 72. The catch 64 may be repositioned on the cord 46 as necessary by exerting a force on the catch 64 relative to the cord 46 sufficient to overcome the friction between the catch 64 and the cord 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hoist apparatus comprising:
a base, said base being hollow and having an open end, said base being elongated between said open end and an opposite end of said base;
a mounting bracket being coupled to a top side of said base, said mounting bracket having a plurality of holes, each hole of said plurality of holes extending vertically through said mounting bracket, said mounting bracket being configured for receiving threaded fasteners through said plurality of holes for mounting said base to a bottom surface of a horizontally projecting structure;
a boom arm being coupled to said base, said boom arm being extendable telescopically away from said base through said open end;
a pulley being coupled to a lower side of said boom arm, said pulley being positioned adjacent to a distal end of said boom arm relative to said base;
a winch being coupled to said bottom side of said base; and
a cord being wound onto said winch, said cord extending around and engaging said pulley, said cord extending downwardly from said pulley and terminating in a free end.

2. The apparatus of claim 1, wherein each hole of said plurality of holes is laterally spaced from said base.

3. The apparatus of claim 1, wherein said mounting bracket is one of a pair of mounting brackets being coupled to said top side of said base, each hole of said plurality of holes extending vertically through an associated mounting bracket of said pair of mounting brackets, said pair of mounting brackets being configured for receiving threaded fasteners through said plurality of holes for mounting said base to a bottom surface of a horizontally projecting structure.

4. The apparatus of claim 3, wherein each hole of said plurality of holes is laterally spaced from said base.

5. The apparatus of claim 1, wherein said base has a notch extending into an outer wall of said base on a bottom side of said base adjacent to said open end for receiving said pulley when said boom arm is retracted toward said base.

6. The apparatus of claim 1, wherein said winch includes a motor for driving said winch.

7. The apparatus of claim 6, wherein said winch is positioned closer to said opposite end of said base than to said open end, said mounting brackets being positioned between said winch and said open end of said base.

8. The apparatus of claim 6, further comprising a controller being operatively coupled to said winch, said controller including an input for selectively winding said cord onto and unwinding said cord from said winch.

9. The apparatus of claim 8, wherein said controller has a first control circuit being electrically coupled to said input, said controller having a transmitter being electrically coupled to said first control circuit for transmitting operational signals to said winch, said winch including a receiver being in signal communication with said transmitter, said winch comprising a second control circuit being electrically coupled to each of said receiver and said motor.

10. The apparatus of claim 1, further comprising a catch being coupled to said cord between said pulley and said free end of said cord, said catch being shaped to engage said pulley such that said cord is fixed relative to said boom arm.

11. The apparatus of claim 10, wherein said catch frictionally engages said cord.

12. The apparatus of claim 1, further comprising a lock engaging said boom arm and said base to releasably secure said boom arm to said base.

13. The apparatus of claim 13, wherein said lock comprises a locking pin extending through said boom arm and said base to secure said boom arm to said base in a selected one of a plurality of locking positions.

14. The apparatus of claim 1, further comprising a hook being coupled to said free end of said cord.

15. A hoist apparatus comprising:
a base, said base being hollow and having an open end, said base being elongated between said open end and an opposite end of said base;
a pair of mounting brackets being coupled to a top side of said base, each mounting bracket of said pair of mounting brackets having a plurality of holes, each hole of said plurality of hole extending vertically through an associated mounting bracket of said pair of mounting brackets, said pair of mounting brackets being configured for receiving threaded fasteners through said plurality of holes for mounting said base to a bottom surface of a horizontally projecting structure, each hole of said plurality of holes being laterally spaced from said base;
a boom arm being coupled to said base, said boom arm being extendable telescopically away from said base through said open end;
a pulley being coupled to a lower side of said boom arm, said pulley being positioned adjacent to a distal end of said boom arm relative to said base, said base having a notch extending into an outer wall of said base on a bottom side of said base adjacent to said open end for receiving said pulley when said boom arm is retracted toward said base;
a winch being coupled to said bottom side of said base, said winch including a motor for driving said winch, said winch being positioned closer to said opposite end of said base than to said open end, said mounting brackets being positioned between said winch and said open end of said base;
a cord being wound onto said winch, said cord extending around and engaging said pulley, said cord extending downwardly from said pulley and terminating in a free end;
a controller being operatively coupled to said winch, said controller including an input for selectively winding said cord onto and unwinding said cord from said winch, said controller having a first control circuit being electrically coupled to said input, said controller having a transmitter being electrically coupled to said first control circuit for transmitting operational signals to said winch, said winch including a receiver being in signal communication with said transmitter, said winch comprising a second control circuit being electrically coupled to each of said receiver and said motor;
a catch being coupled to said cord between said pulley and said free end of said cord, said catch being shaped to engage said pulley such that said cord is fixed relative to said boom arm, said catch frictionally engaging said cord;
a lock engaging said boom arm and said base to releasably secure said boom arm to said base, said lock comprising a locking pin extending through said boom arm and said base to secure said boom arm to said base in a selected one of a plurality of locking positions; and
a hook being coupled to said free end of said cord.
